(19) United States
(12) Patent Application Publication
(10) Pub. No.: US 2017/0159317 A1
(43) Pub. Date: Jun. 8, 2017

(54) Fire Shelter

(71) Applicant: Safety Of The World Pty Ltd, Milton (AU)

(72) Inventor: Tune Eliot Johansen, Mitchelton (AU)

(21) Appl. No.: 15/339,139

(22) Filed: Oct. 31, 2016

(30) Foreign Application Priority Data
Dec. 1, 2015 (AU) 2015904975
Mar. 31, 2016 (AU) 2016100344

(51) Int. Cl. E04H 9/14; E04H 1/12; E04B 1/343; E04B 2/00; E02D 27/02; E02D 27/32; E06B 5/16; E04C 2/288; E04H 1/00; E04B 1/94

(52) U.S. Cl. CPC E04H 9/14; E04H 1/005; E04H 1/1205; E04B 1/34321; E04B 1/34384; E04B 1/941; E04B 1/948; E04B 1/946; E02D 27/02; E02D 27/32; E06B 5/164; E04C 2/288; E04C 2/46

(57) ABSTRACT

A fire shelter including: a foundation including a slab; an internal frame mounted on the slab; external cladding formed from heat resistant masonry panels supported by the internal frame, the external cladding including wall cladding including wall panels and defining a door opening and roof cladding including roof panels; and a door mounted in the door opening, the door including a door frame hingedly connected to the internal frame adjacent to the door opening and door cladding including door panels formed from heat resistant masonry panels supported by the door frame, wherein when the door is in a closed position, the door cladding closes the door opening.

### BACKGROUND OF THE INVENTION

This invention relates to a fire shelter, particularly for above ground construction.

### Description of the Prior Art

Bushfires are frequent events in many parts of Australia due to its hot and dry climate, and pose a serious risk to property owners. Many lives have been lost due to failures to evacuate a at-risk area in time before a fire front arrives, decisions to remain at their property and attempt to fight off fires, or attempts to take refuge inside their house and being trapped without inadequate shelter.

Fire bunkers have been proposed as a refuge for property owners that are unable to evacuate or opt to remain with their properties. These are typically provided as self-contained capsules constructed of steel or concrete which are buried underground, with the occupant able to access the internal volume via a hatch in the ground.

For example, AU2009101097B4 discloses a fire bunker comprising an elongated structure formed from a solid material able to be at least partially buried and resist fire having a primary chamber and an adjacent secondary chamber wherein the primary chamber is substantially sealable with an access fireproof door leading from the secondary ante chamber. In another example, AU2010100213B4 discloses a fire retreat shelter suitable for placement below ground in a pit of appropriate dimensions comprising a substantially cuboid structure which provides a space suitable for sheltering occupants during a fire.

However, there is a significant risk of trees or debris falling over the hatch of a buried fire bunker and trapping the occupants inside. In addition, such buried fire bunkers require entry by a ladder and thus cannot be accessed by wheelchair users or other users with mobility impairments. Furthermore, buried fire bunkers of these types are expensive to build, transport and install. The installation of buried fire bunkers will typically require the deployment of heavy construction machinery, which may not be feasible in remote locations.

It is therefore desirable to provide an alternative form of fire shelter that can be constructed above ground using conventional construction techniques.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a broad form the present invention seeks to provide a fire shelter including:
a) a foundation including a slab;
b) an internal frame mounted on the slab;
c) external cladding formed from heat resistant masonry panels supported by the internal frame, the external cladding including:
   i) wall cladding including wall panels and defining a door opening; and,
   ii) roof cladding including roof panels; and,
d) a door mounted in the door opening, the door including:
   i) a door frame hingedly connected to the internal frame adjacent to the door opening; and,
   ii) door cladding including door panels formed from heat resistant masonry panels supported by the door frame, wherein when the door is in a closed position, the door cladding closes the door opening.

Typically the heat resistant masonry panels include pumice.

Typically the heat resistant masonry panels are formed from a pumice concrete including pumice and cement.

Typically the foundation includes a footing extending around a perimeter of the slab, a bottom row of the wall panels resting on the footing.

Typically the footing is offset outwardly from an outside edge of the slab.

Typically the footing is separated from the outside edge of the slab by a gap.

Typically the gap is filled with soil.

Typically the footing defines an upper footing surface that is lower than an upper slab surface defined by the slab.

Typically the bottom row of the wall panels extends beneath the upper slab surface and abuts the outside edge of the slab.

Typically the roof cladding overhangs the wall cladding.

Typically the roof cladding includes two layers of roof panels.

Typically the roof panels of each of the two layers are arranged to ensure that joints between roof panels in different layers are not aligned.

Typically the roof panels of each of the two layers are arranged in at least one of:
a) a staggered arrangement; and,
b) an overlapping arrangement.

Typically the wall cladding includes interlocking joints between adjacent wall panels.

Typically a perimeter of the door opening is surrounded by wall panels.

Typically the door cladding extends beyond the perimeter of the door opening to thereby overlap the surrounding wall panels when the door is in the closed position.

Typically the door includes an escape region of the door cladding is not covered by any part of the door frame, such that the escape region of the door cladding may be broken and removed to form an escape opening through the door.

Typically the door frame includes:
a) edge beams;
b) a brace extending between edge beams; and,
c) door battens attached to edge beams and the brace, the door panels being fastened to the wall battens.

Typically the internal frame includes wall framing including:
a) posts mounted on the slab;
b) girts coupled between adjacent posts; and,
c) wall battens attached to the girts, the wall panels being fastened to the wall battens.

Typically the internal frame includes roof framing including:
a) beams mounted atop posts mounted on the slab;
b) rafters coupled between beams; and,
c) roof battens attached to the rafters, the roof panels being fastened to the roof battens.

Typically the fire shelter includes a sub-floor elevated above the slab.

In another broad form, the present invention seeks to provide a heat resistant door including:
a) a door frame configured to be hingedly connected to a structural frame adjacent to a door opening in a structure; and,
b) door cladding including door panels formed from heat resistant masonry panels supported by the door frame, wherein when the door is in a closed position, the door cladding closes the door opening.

Typically the heat resistant masonry panels include pumice.

Typically the heat resistant masonry panels are formed from a pumice concrete including pumice and cement.

Typically the door includes an escape region of the door cladding is not covered by any part of the door frame, such that the escape region of the door cladding may be broken and removed to form an escape opening through the door.

Typically the door frame includes:
a) edge beams;
b) a brace extending between edge beams; and,
c) door battens attached to edge beams and the brace, the door panels being fastened to the door battens.

### BRIEF DESCRIPTION OF THE DRAWINGS

An example of the present invention will now be described with reference to the accompanying drawings, in which:

FIG. 1A is a perspective view of a first example of a fire shelter;

FIG. 1B is a front view of the fire shelter of FIG. 1A showing a door of the fire shelter;

FIG. 1C is a cross section view of the fire shelter of FIG. 1A showing part of a foundation and an internal frame of the fire shelter;

FIG. 2A is a front view of an example of the door of FIG. 1B showing door framing of the door;

FIG. 2B is a side view of the door and door framing of FIG. 2A;

FIG. 3A is an end view of a second example of a fire shelter;

FIG. 3B is a plan view of the fire shelter of FIG. 3A showing wall framing of the fire shelter;

FIG. 3C is a plan view of the fire shelter of FIG. 3A showing roof framing of the fire shelter;

FIG. 3D is a cross section view of the fire shelter taken at section A-A′ of FIG. 3C showing framing along an end wall of the fire shelter;

FIG. 3E is a cross section view of the fire shelter taken at section B-B′ of FIG. 3C showing framing across a centre of the fire shelter;

FIG. 3F is a cross section view of the fire shelter taken at section C-C′ of Figure showing framing along a side wall of the fire shelter;

FIG. 4A is a plot of external and internal wall temperatures of a fire shelter during fire testing;

FIG. 4B is a plot of the internal wall temperatures during the fire testing of FIG. 4A, at a magnified scale; and,

FIG. 4C is a plot of internal air temperatures within the fire shelter during the fire testing of FIG. 4A.

### DETAILED DESCRIPTION OF THE PREFERRED EMBODIMENTS

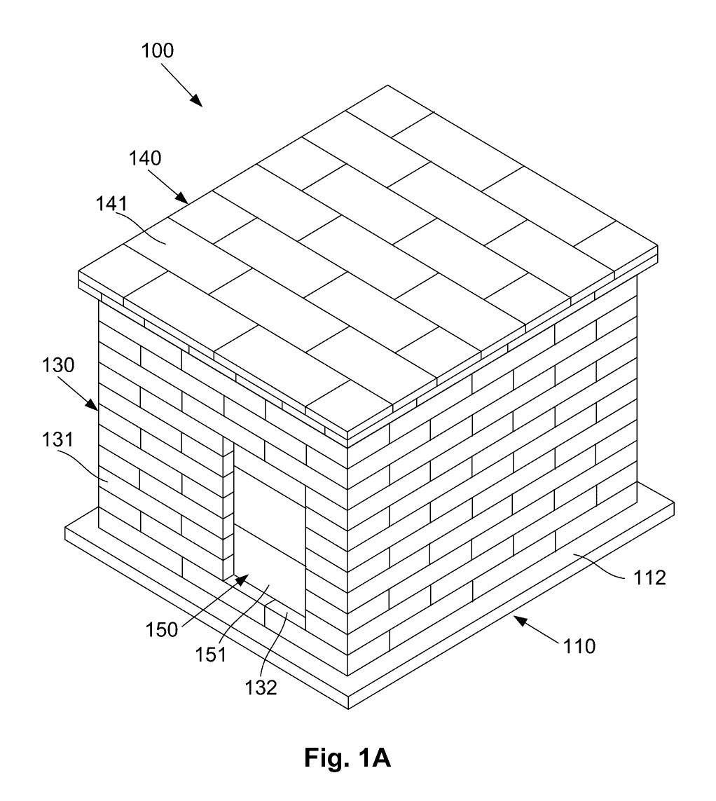

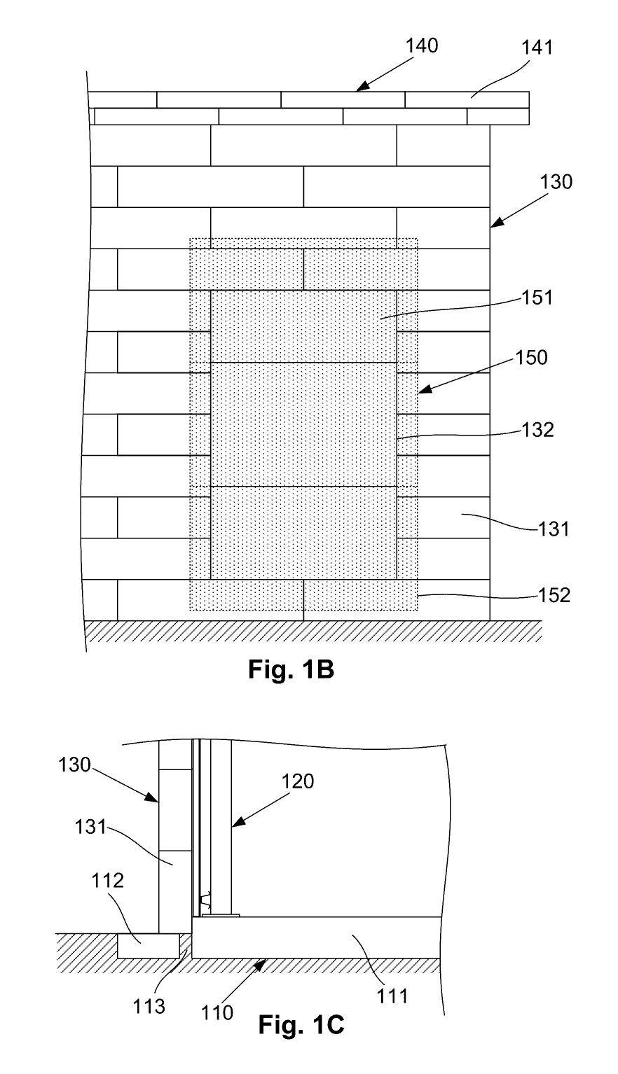

An example of a fire shelter 100 will now be described with reference to FIGS. 1A to 1C.

In broad terms, the fire shelter 100 includes a foundation 110 including a slab 111, an internal frame 120 mounted on the slab 111, external cladding formed from heat resistant masonry panels supported by the internal frame 120. The external cladding includes wall cladding 130 including wall panels 131 and defining a door opening 132, and roof cladding 140 including roof panels 141. The fire shelter 100 further includes a door 150 mounted in the door opening 132.

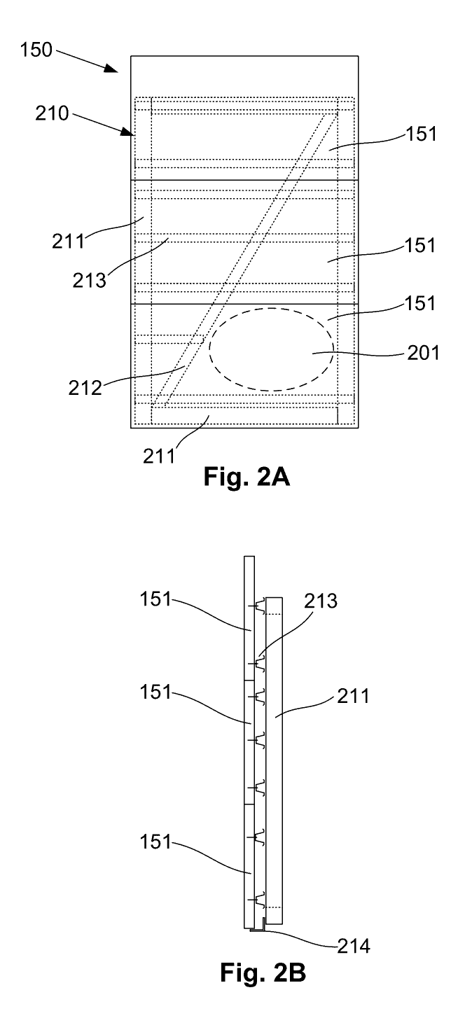

With regard to the example of the door 150 shown in FIGS. 2A and 2B, the door includes a door frame 210 that is hingedly connected to the internal frame 120 adjacent to the door opening 132, and door cladding including door panels 151 formed from heat resistant masonry panels supported by the door frame 210, wherein when the door 150 is in a closed position, the door cladding closes the door opening 142.

It will be appreciated that the fire shelter 100 is suitable for above ground installation utilising conventional building construction techniques. In contrast to conventional bunker constructions, the fire shelter 100 does not need to be buried underground and hence no excavation is required. Furthermore, above ground installation of the fire shelter 100 reduces the risk of occupants being trapped inside the fire shelter 100 compared to a buried bunker.

The heat resistant masonry panels used to provide the external cladding (the wall panels 131 and the roof panels 141) and the door cladding (the door panels 151) effectively provide a heat resistant shell which insulates occupants of the fire shelter 100 from external heat, such as in the event of a bushfire.

A suitably configured fire shelter 100 is capable of maintaining the internal temperature inside the fire shelter 100 at comfortable levels during sustained extreme external temperature conditions, thus allowing occupants to take refuge from bushfire events or the like which might otherwise not be survivable. Accordingly, the fire shelter 100 may be used by property owners who are unable to evacuate in time or who choose to stay and defend their property.

The heat resistant masonry panels may include pumice, which is a natural insulator material known to have exceptional heat resistance properties, yet is relatively lightweight. Although panels formed from pure pumice rock may be used, in some examples, the heat resistant masonry panels may be formed from a pumice concrete including pumice and cement. In some examples, the pumice concrete may be fibre reinforced.

Suitable pumice-based heat resistant masonry panels are commercially available, such as under the ISOKERN brand. Existing pumice-based heat resistant masonry panels are conventionally used in the construction of fireplaces and chimneys, where they have proven their suitability for use in high temperature environments. It is noted that pumice-based materials are also known to be a fire resistant or “fire proof” materials, in that they will maintain their structural integrity when exposed to fire for prolonged periods. This is a desirable property of the heat resistant masonry panels for withstanding fire conditions.

Suitable alternative materials for forming the heat resistant masonry panels may include known refractory materials such as those used for linings in furnaces, kilns and the like, although pumice-based materials provide a good combination of relatively low weight and cost compared to other heat resistant materials.

The joints between the heat resistant masonry panels will ideally be sealed with a suitable mortar, grout, or the like to prevent heat leakage between the joints. In one example an epoxy grout is used, with all joints sealed.

Further preferred or optional details of the fire shelter 100 will now be described.

In this example, the foundation 110 includes a footing 112 extending around a perimeter of the slab 112. The footing 112 will typically be embedded into the ground. With regard to the cross section view of FIG. 1C, it can be seen that a bottom row of the wall panels 131 rests on the footing 112. Whilst the wall panels 131 are supported by the internal framing 120 as shown, it is desirable to also have the wall panels 131 rest on a stable footing 112. This can provide some structural redundancy and also helps to avoid gaps at the base of the wall cladding which might otherwise allow heat to enter the internal volume of the fire shelter 100.

As can be seen in FIGS. 1A and 1C, the footing 112 may be offset outwardly from an outside edge of the slab 111. In some examples, the footing 112 may be separated from the outside edge of the slab 111 by a gap 113. This can help to reduce or prevent heat transfer to the slab 111 via the footing 112. It may be desirable to have the gap 113 filled with soil as shown in FIG. 1C. It will be appreciated that this can be easily achieved when constructing the slab 111 and the footing 112 embedded in soil of the construction site.

In the example of FIG. 1C, the footing 112 defines an upper footing surface that is lower than an upper slab surface defined by the slab 111. In other words, the top of the slab 111 is elevated above the top of the footing 112. The bottom row of the wall panels 131 may thus extend beneath the upper slab surface and abut the outside edge of the slab 111. It will be appreciated that this will result in the wall panels 131 providing a heat resistant barrier that extends beneath the slab 111.

Turning to the roof cladding 140 of the fire shelter 100, the roof cladding 140 may overhang the wall cladding 130 as shown in FIGS. 1A and 1B. In this example, the roof cladding 140 includes two layers of roof panels 141, which can be advantageous in providing improved resistance to damage from falling branches, debris or the like. The roof panels 141 of each of the two layers may be arranged to ensure that joints between roof panels 141 in different layers are not aligned. This can help to reduce the likelihood of a falling object penetrating through both layers of the roof panels and ensure that there is no direct heat transfer path from the exterior to the interior of the fire shelter 100 in the event of joint failures. To facilitate this, the roof panels 141 of each of the two layers may be arranged in a staggered or overlapping arrangement as can be seen in FIGS. 1A and 1B. The roof panels 141 in different layers may also have their respective elongation directions rotated by 90 degrees.

In some examples, the wall cladding 130 may include interlocking joints between adjacent wall panels 131. This can increase the resilience of the wall cladding 130 against impacts and also help to prevent heat transfer through the joints.

With regard to the door 150, a perimeter of the door opening 132 may be surrounded by wall panels 131 as shown in the example of FIGS. 1A and 1B. Thus, the door 150 may interface with these surrounding wall panels 131 to provide a heat resistant closure of the door opening 132. In this example, the door 150 is inset inside the wall panels 131 as best seen in FIG. 1A. FIG. 1B shows the extents of the door with hidden detail relative to the door opening 132. It will be appreciated that, in this example, the door cladding extends beyond the perimeter of the door opening 132 to thereby overlap the surrounding wall panels 131 when the door 150 is in the closed position.

A heat resistant sealing material may be provided in the overlapping region of the door 150 and wall panels 131 surrounding the door opening 132, to form a more effective seal when the door 150 is in the closed position. In one example, glass fibre rope is arranged in the overlapping region to seal the door 150. Typically, the glass fibre rope will be arranged to form a continuous seal surrounding the door opening 132. In some embodiments, two glass fibre rope seals may be provided, with each seal forming a closed perimeter around the door opening 132. The glass fibre rope may be attached to either the outer surface of the door 150 or the inner surface of the wall panels 131 surrounding the door opening 132, and in the case where two seals are provided, one may be attached to each of the door and the wall panels 131 surrounding the door opening 132.

Alternatively or additionally, the heat resistant masonry panels about the perimeter of the door 150 and/or the door opening 132 may have a stepped configuration or the like so that the of the door panels 151 and corresponding wall panels 131 surrounding the door opening 132 are able to interlock for improved sealing.

In some examples, the door frame 151 may be hingedly connected to the internal frame 120 of the fire shelter 120 using a hinge arrangement that allows the door 150 to be swung in an arc between an open position and a partially closed position in which the door 150 is aligned with the door opening 132, and subsequently translated into a fully closed position in which the door 150 more effectively seals the door opening 132.

The door 150 may be retained in the closed position by any suitable latch, and in some examples, the latch may be configured to require a positive action to retain the door in the closed position. In one embodiment, the latch is located in a sufficiently elevated position to prevent operation by children, and thus reduce the risk of children becoming trapped in the fire shelter 100.

The door 150 may be opened by swinging the door 150 inwardly into the fire shelter 100. It will be appreciated that this can allow the door 150 to be opened, after any external heat has subsided to safe levels (such as when a bushfire has safely passed), even if falling debris blocks the door opening 132 from the outside. This can greatly reduce the likelihood of occupants becoming trapped inside the fire shelter 100.

Nevertheless, the door 150 may also be configured to allow occupants to escape from the fire shelter 100, even if the door 150 cannot be opened, such as due to the door 150 becoming jammed in the door opening 132. In one example, the door 150 may include an escape region 201 of the door cladding that is not covered by any part of the door frame 210 as shown in FIG. 2A, such that the escape region 201 of the door cladding may be broken and removed to form an escape opening through the door 150. It will be appreciated that the door panel 151 extending across the escape region 201 will have an unsupported area that may be more easily broken to enable escape than regions directly supported on parts of the door frame 210. An occupant may be able to break the escape region 201 by kicking or by using a tool such as a hammer or mallet which may be supplied with the fire shelter 100.

It will also be appreciated that the escape region 201 may be broken by emergency services personnel to allow occupants to be rescued from the fire shelter 100 in the event they are trapped by fallen debris. In one example, an indication of the escape region 201 may be marked on the outer surface of the door cladding in the vicinity of the escape region 201. For instance, the indication could be in the form of an outline of the escape region 201 and may include instructions for indicating how to break the escape region 201.

With further regard to FIGS. 2A and 2B, the door frame 210 in this example includes edge beams 211 which define the outside boundary of the door frame 210, a brace 212 extending between edge beams 210, in this case diagonally across the door 150, and door battens 213 attached to edge beams 210 and the brace 212. The door panels 151 are fastened to the door battens 213. In this example, only a single layer of door panels 151 are provided on the door, although in an alternative example, two layers of door panels 151 may be provided. These two layers may be arranged to avoid aligned joints as discussed above for the roof panels 141. In one example, the inner layer of door panels 151 may be fastened to the door battens 213 and the outer layer of door panels 151 may be fastened to the inner layer of door panels 151.

The door frame 210 may include an angle bracket 214 along its lower edge for supporting the lowermost door panel 151, as shown in FIG. 2B. This can allow the lowermost door panel 151 to be rested on the angle bracket 214 during assembly of the door 150, and each higher door panel 151 may be rested on the door panel 151 below it as the door panels 151 are attached to the door frame in turn 210.

The door frame 210 may be formed from any suitable structural framing material, and in this case the door frame 210 components 210 are formed from steel. In this example, the edge beams 211 and the brace 212 are formed using hollow square or rectangular cross section members whilst the door battens 213 are formed using top hat section members, or the like.

It will be appreciated that a door 150 with construction as discussed above may be provided separately from the fire shelter 100 as a heat resistant fire door for use in other types of buildings. Such a heat resistant door would thus include a door frame 210 configured to be hingedly connected to a structural frame adjacent to a door opening in a structure, and door cladding including door panels 151 formed from heat resistant masonry panels supported by the door frame 210, wherein when the door is in a closed position, the door cladding closes the door opening.

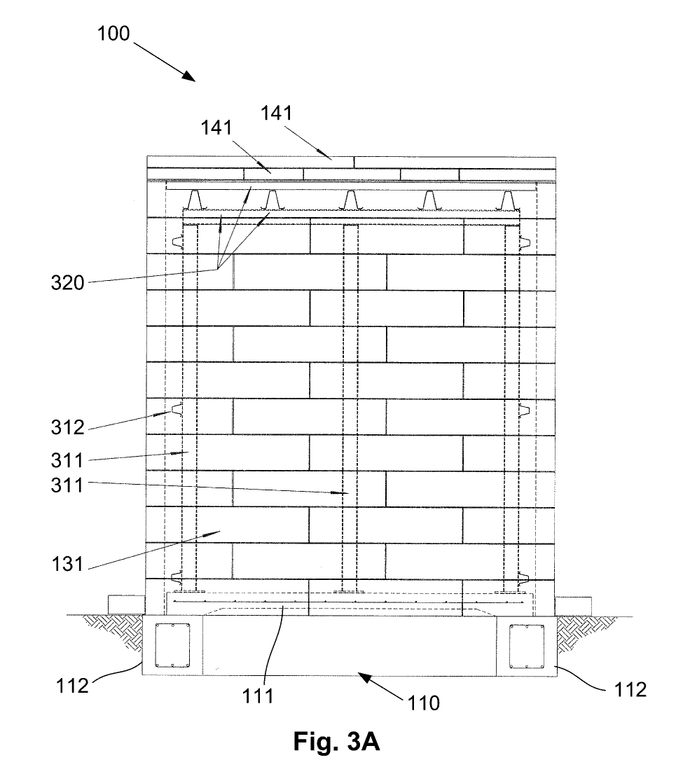

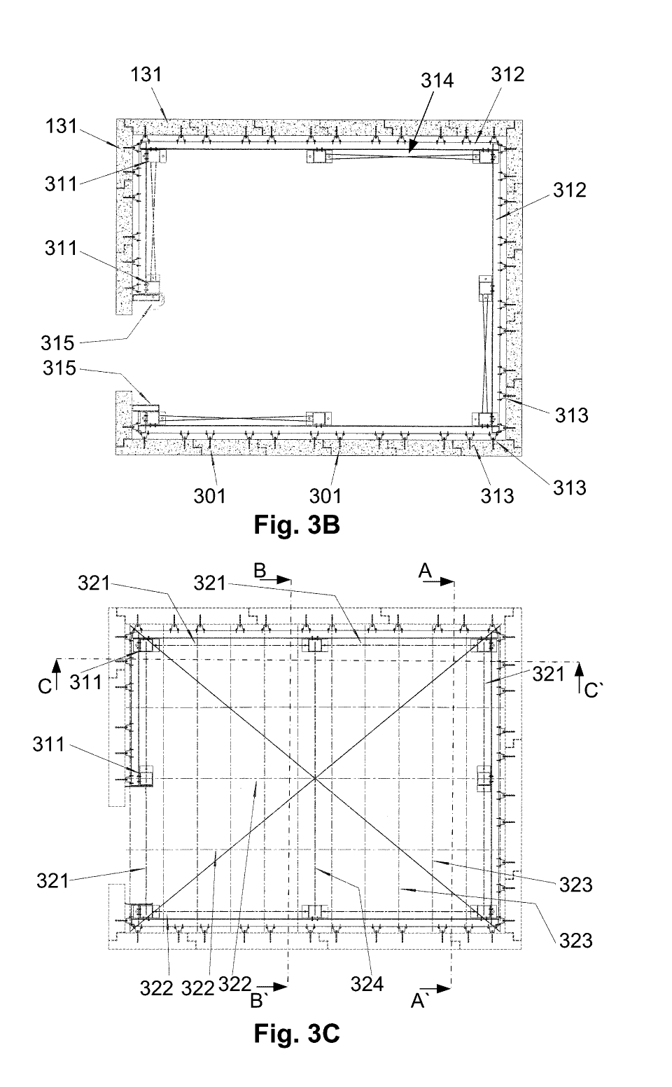

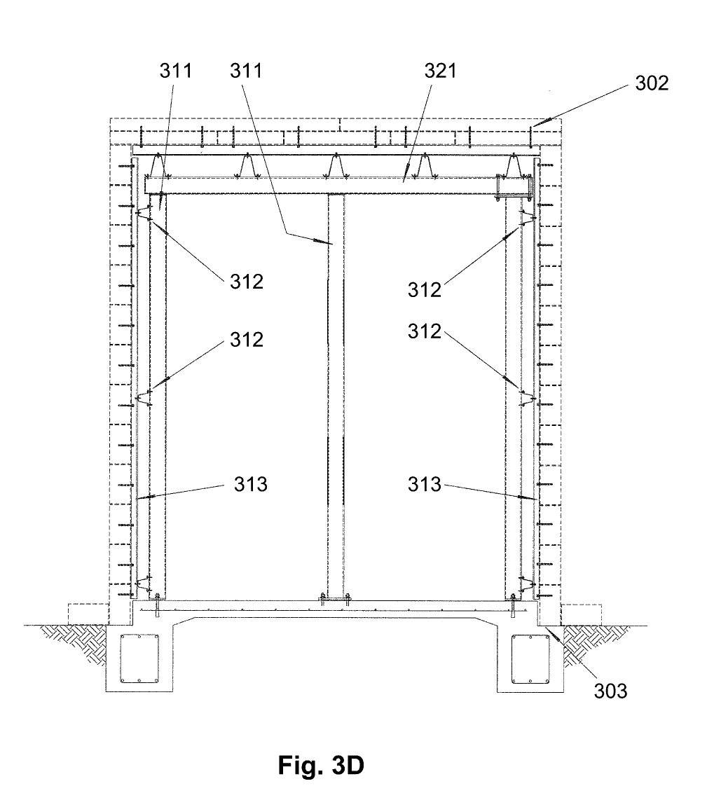

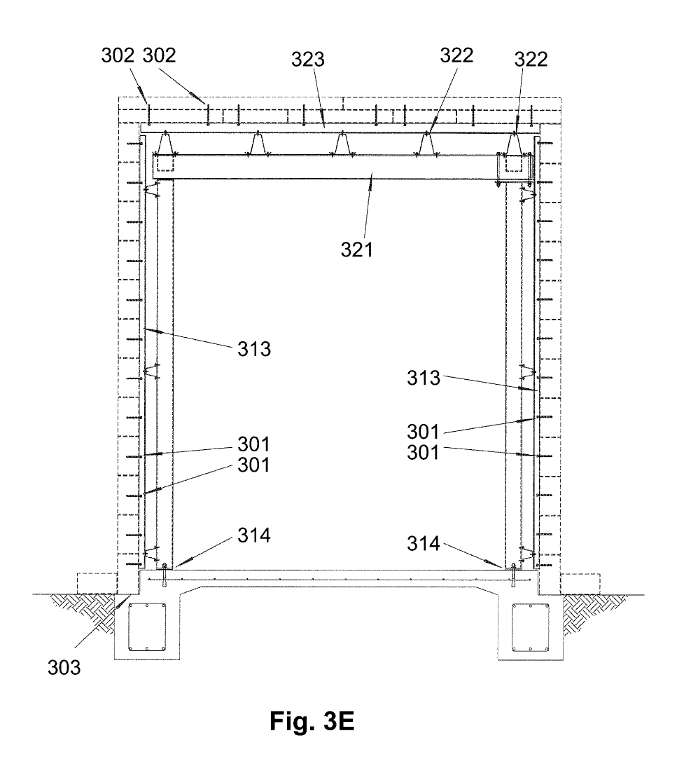

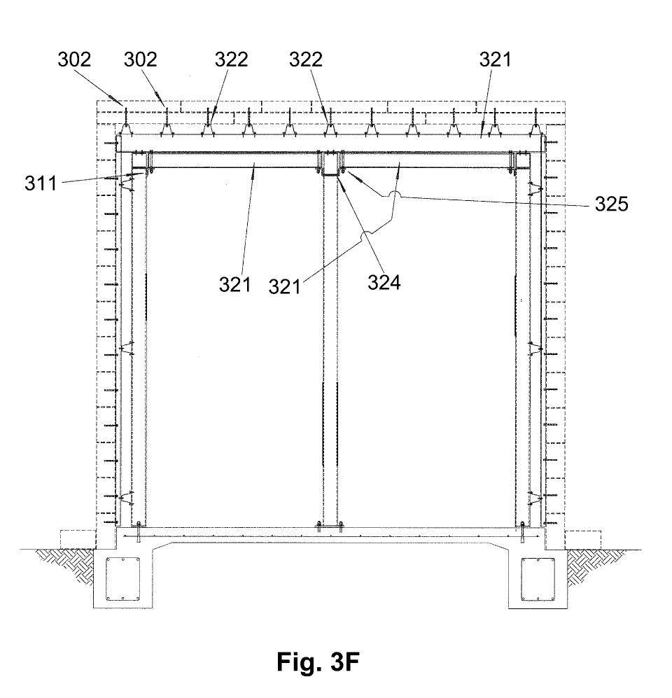

Additional details of the internal frame 120 along with a range of other optional features will now be discussed with regard to a further example of a fire shelter 300 as shown in FIGS. 3A to 3F.

It is noted that the fire shelter 300 in this example includes some variations in design compared to the earlier example of the fire shelter 100. For instance, the roof cladding 140 in this example of the fire shelter 300 does not overhang the wall cladding 130, and the footing 112 of the foundation 110 is embedded into the ground beneath the slab 111 and not offset outwardly from the slab 111 or separated from the outside edge of the slab by a gap 113 as per the earlier example of the fire shelter 100. However, it should be appreciated that features of each example are generally interchangeable.

With regard to FIGS. 3A to 3F, the internal frame may include wall framing 310 including posts 311 mounted on the slab 111, girts 312 coupled between adjacent posts 311, and wall battens 313 attached to the girts 312. The wall panels 131 are fastened to the wall battens 313 in this example, using suitable fasteners 301, such as screw bolts. The internal frame may include roof framing 320 including beams 321 mounted atop the posts 311, rafters 322 coupled between beams 321, and roof battens 323 attached to the rafters 322. The roof panels 141 are fastened to the roof battens 323 in this example, using suitable fasteners 302 such as screw bolts 302, which are selected to have sufficient length to extend through the bottom layer of the roof panels 141 and penetrate the top layer of the roof panels 141 to thereby secure both layers.

FIG. 3A shows an end view of the fire shelter 300 with hidden detail of the foundation 110 and the internal frame 120. The plan view of FIG. 3B shows the interlocked joints between the wall panels 131, which may also be sealed with epoxy adhesive to provide a gas-proof joint. The wall panels 131 are also in a staggered arrangement, and the corners of the wall cladding 130 may also include interlocked joints. It can also be seen that two fasteners 301 are used for attaching each wall panel 131 to a wall batten 313. At least one fastener 302 is used per roof batten for attaching each roof panel 141. Bracing 314 is provided between the posts 311. Optional door jamb framing 315 may be arranged about the door opening 132 for aiding sealing around the door 150. FIG. 3C indicates further details of the roof framing 320, where it can be seen that the rafters 322 extend longitudinally along the length of the fire shelter 300 and the roof battens 323 extend laterally along the width of the fire shelter. A central beam 324 may extend across the centre of the fire shelter 300 to provide additional support for the roof cladding 140.

FIGS. 3D, 3E and 3F are cross section views taken at sections A-A′, B-B′ and C-C′, of FIG. 3C, respectively. FIG. 3D shows framing along an end wall of the fire shelter 300, FIG. 3E shows framing across the centre of the fire shelter 300, and FIG. 3F shows framing along a side wall of the fire shelter 300. With regard to FIG. 3E, it can be seen that the central beam 324 has a deeper cross section compared to the regular beams 321 about the sides of the roof framing 320. A damp proof course (DPC) may be provided under the wall panels 131 and extending up the face of the slab 111, as indicated by arrow 303, to prevent moisture rising to the level of the slab 111. FIG. 3E indicates the mounting plates 314 for allowing the posts 311 to be mounted to the slab 111. In FIG. 3F, it can be seen that angle brackets 325 may be attached to the central beam 324, such as by welding, to facilitate connection to other beams 321 of the roof framing 320.

In this example, the internal framing is formed from steel. The posts 311 and beams 321 are provided using square hollow section members, the central beam 324 uses a rectangular hollow section member, whilst the girts 312, rafters 322 and battens 213, 323 each use suitably sized top hat section members. It will be understood that this simple construction, using readily available structural steel members, can allow the internal framing structure to be erected at low cost and without the need for specialised labour or equipment.

With regard to the foundation 110 in this example, the footing 112 is provided as a generally square section concrete beam embedded into the ground about a perimeter of the fire shelter 300. The elevated slab 111 bridges across the footing 112. The footing 112 and slab 111 will typically be steel reinforced.

It should be appreciated that the particular structural arrangement of the internal framing is for the sake of example only and variations will be readily apparent to those skilled in the art of structural design for buildings.

Although the slab 111 will typically provide the floor of the fire shelter 100, in some examples, the fire shelter 111 may include a sub-floor (not shown) that is elevated above the slab 111. The sub-floor may be perforated to allow heavier-than-air gases to settle below the level of the sub-floor so that these do not immediately accumulate in the main occupant volume of the fire shelter 100.

It is noted that the fire shelter 100 defines a closed volume, and thus only includes a limited volume of air for occupants to breathe. It is envisaged that breathing masks and air cylinders would be provided for each occupant to provide an adequate air supply and guard against the risk of breathing air being sucked out of the fire shelter 100 if the fire shelter 100 is imperfectly sealed.

The fire shelter 100 may include one or more viewing ports (not shown) for allowing occupants to assess whether conditions are safe to exit the fire shelter 100. The viewing ports may be provided by installing a suitably configured heat resistant glass block into the wall cladding 130 or door cladding 150, depending on viewing requirements. The glass block will ideally be selected to have similar heat resistant properties compared to the heat resistant panels used to form the cladding of the fire shelter 100, but should at least be capable of maintaining its structural integrity for a sufficient duration based on the design requirements for the fire shelter 100. In any event, the size of any viewing port should be minimised to avoid compromising the heat resistance of the overall fire shelter 100. It is noted that the viewing port only needs to be sufficiently large to allow an occupant to look outside with one eye to determine whether or not the fire has passed through the area.

A fire shelter 100 has been constructed in accordance with the above examples and tested in simulated bushfire conditions for over two hours, to confirm the safety of the fire shelter 100. Wall temperature sensors in the form of thermocouples were arranged on external and internal locations on the wall cladding 130 and air temperature sensors were also provided inside the fire shelter 100.

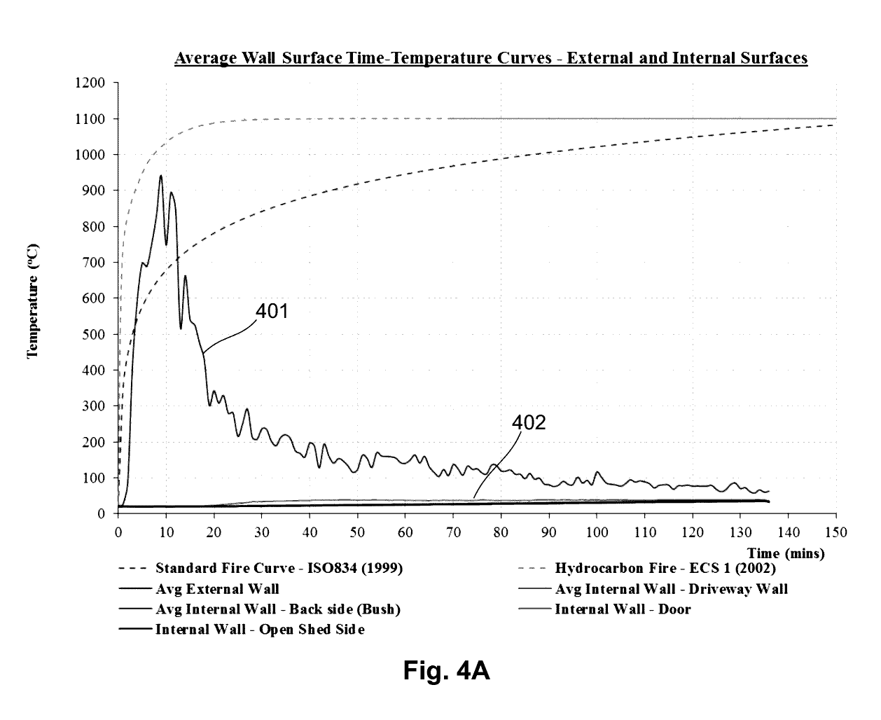

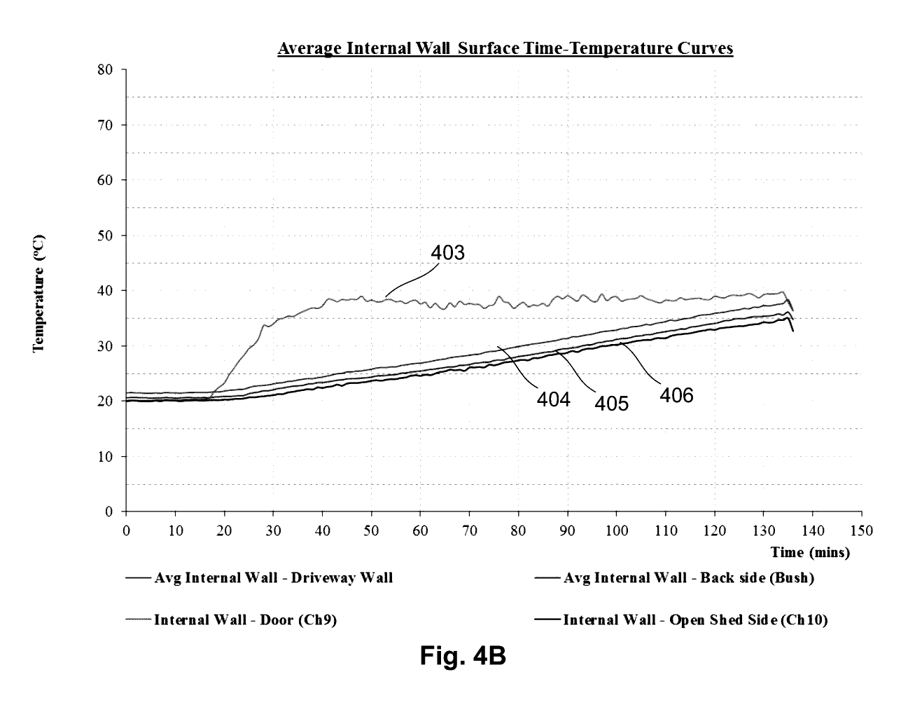

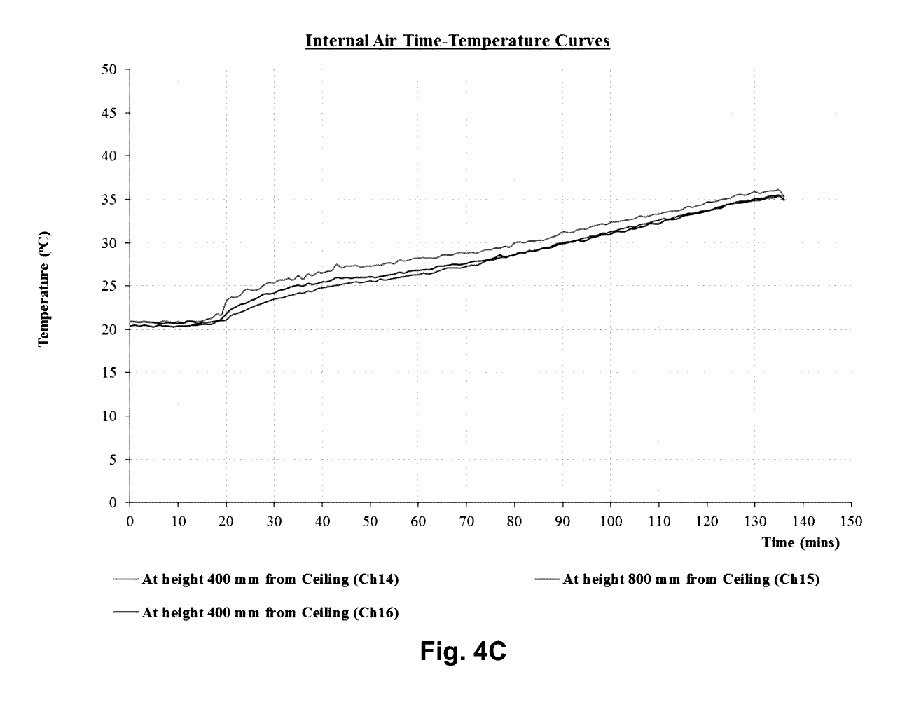

Results of this test are shown in FIGS. 4A to 4C. General trends of the results will first be outlined, followed by a more detailed summary of the specific results.

FIG. 4A shows the average wall temperatures during the test, with the external wall temperature indicated by 401 and the traces of the internal wall temperatures generally indicated by 402. FIG. 4B shows a magnified view of these internal temperatures, where the internal wall temperature sensor mounted at the door (403) experienced a greater temperature rise compared to the internal wall temperature sensors mounted at other locations of the walls (404, 405, 406). In any event, it can be seen that although the average external wall temperature reached a maximum above 900° C. and remained above 100° C. for over an hour, the average internal wall temperature did not exceed 40° C. FIG. 4C shows the internal air temperatures at different positions, and it is noted that the air temperate similarly remained under 40° C. throughout the test, only exceeding 35° C. after two hours.

Further specific results of the test are summarised below:
External surface temperature reached a maximum of 1030° C. in a first thermocouple channel after 10 minutes of fire exposure, and in a second thermocouple channel it was 993° C. after 9 minutes.
From the start of the fire test, within 3 minutes, external surface temperatures reached well above 500° C. in both external surface temperature channels. This means that the flashover time period was about 3 minutes.
External surface temperatures were well above 500° C. for 15 minutes of fire exposure and after that it started to gradually decrease in the decay phase of the fire.
External surface temperatures in both channels were above 100° C. for about 90 minutes of fire exposure.
External surface temperatures in both channels showed a rapid temperature rise, as seen by comparison to the standard fire curves (ISO curve (1999) and Hydrocarbon Curve in Eurocode 1 (2002)).
Internal surface temperatures on three walls were less than 25° C. for the first 20 minutes, and thereafter gradually started to increase and reached about 35° C. after 2 hours of fire exposure.
Internal surface temperature on the door showed a rapid temperature rise after about 18 minutes of fire exposure and reached a temperature of 37° C. in 40 minutes and remained a constant until 2 hours of fire exposure.
The average internal surface temperatures in three walls and door showed that the internal surface reached about 40° C., after almost 2 hours of fire exposure.
Internal surface temperatures decreased after 134th minute of fire exposure.
The internal air temperatures measured at 400 and 800 mm depth from the roof near the door also recorded a maximum of 35° C. after 2 hours of fire exposure.

From these test results, it can be seen that the internal wall and air temperature remain within a survivable and even comfortable range for occupants during temperature conditions similar to those encountered in an extreme bushfire event.

Accordingly, the fire shelter 100 provides a means for individuals to seek refuge from bushfires or the like, using straightforward construction techniques using commercially available materials. This is in stark contrast to traditional solutions such as buried bunkers which are typically expensive purpose built structures which are difficult to construct, transport and install.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A fire shelter including:
a) a foundation including a slab;
b) an internal frame mounted on the slab;
c) external cladding formed from heat resistant masonry panels supported by the internal frame, the external cladding including:
i) wall cladding including wall panels and defining a door opening; and,
ii) roof cladding including roof panels; and,
d) a door mounted in the door opening, the door including:
i) a door frame hingedly connected to the internal frame adjacent to the door opening; and,
ii) door cladding including door panels formed from heat resistant masonry panels supported by the door frame, wherein when the door is in a closed position, the door cladding closes the door opening.

2) A fire shelter according to claim 1, wherein the heat resistant masonry panels at least one of:
a) include pumice; and,
b) are formed from a pumice concrete including pumice and cement.

3) A fire shelter according to claim 1, wherein the foundation includes a footing extending around a perimeter of the slab, a bottom row of the wall panels resting on the footing.

4) A fire shelter according to claim 3, wherein the footing is offset outwardly from an outside edge of the slab.

5) A fire shelter according to claim 4, wherein the footing is separated from the outside edge of the slab by a gap.

6) A fire shelter according to claim 5, wherein the gap is filled with soil.

7) A fire shelter according to claim 4, wherein the footing defines an upper footing surface that is lower than an upper slab surface defined by the slab.

8) A fire shelter according to claim 7, wherein the bottom row of the wall panels extends beneath the upper slab surface and abuts the outside edge of the slab.

9) A fire shelter according to claim 1, wherein the roof cladding overhangs the wall cladding.

10) A fire shelter according to claim 1, wherein the roof cladding includes two layers of roof panels.

11) A fire shelter according to claim 10, wherein the roof panels of each of the two layers are at least one of:
a) arranged to ensure that joints between roof panels in different layers are not aligned; and,
b) arranged in at least one of:
i) a staggered arrangement; and,
ii) an overlapping arrangement.

12) A fire shelter according to claim 1, wherein the wall cladding includes interlocking joints between adjacent wall panels.

13) A fire shelter according to claim 1, wherein a perimeter of the door opening is surrounded by wall panels.

14) A fire shelter according to claim 13, wherein the door cladding extends beyond the perimeter of the door opening to thereby overlap the surrounding wall panels when the door is in the closed position.

15) A fire shelter according to claim 1, wherein at least one of:
a) the door includes an escape region of the door cladding is not covered by any part of the door frame, such that the escape region of the door cladding may be broken and removed to form an escape opening through the door; and,
b) the door frame includes:
i) edge beams;
ii) a brace extending between edge beams; and,
iii) door battens attached to edge beams and the brace, the door panels being fastened to the wall battens.

16) A fire shelter according to claim 1, wherein the internal frame includes at least one of:
a) wall framing including:
i) posts mounted on the slab;
ii) girts coupled between adjacent posts; and,
iii) wall battens attached to the girts, the wall panels being fastened to the wall battens; and,
b) roof framing including:
i) beams mounted atop posts mounted on the slab;
ii) rafters coupled between beams; and,
iii) roof battens attached to the rafters, the roof panels being fastened to the roof battens.

17) A fire shelter according to claim 1, wherein the fire shelter includes a sub-floor elevated above the slab.

18) A heat resistant door including:
a) a door frame configured to be hingedly connected to a structural frame adjacent to a door opening in a structure; and,
b) door cladding including door panels formed from heat resistant masonry panels supported by the door frame, wherein when the door is in a closed position, the door cladding closes the door opening.

19) A fire shelter according to claim 18, wherein the heat resistant masonry panels at least one of:
a) include pumice; and,
b) are formed from a pumice concrete including pumice and cement.

20) A fire shelter according to claim 18, wherein at least one of:
a) the door includes an escape region of the door cladding is not covered by any part of the door frame, such that the escape region of the door cladding may be broken and removed to form an escape opening through the door; and,
b) the door frame includes:
i) edge beams;
ii) a brace extending between edge beams; and,
iii) door battens attached to edge beams and the brace, the door panels being fastened to the door battens.
